(19) United States
(12) Patent Application Publication
(10) Pub. No.: US 2023/0017774 A1
(43) Pub. Date: Jan. 19, 2023

(54) PROACTIVE CONTROL OF VEHICLE SYSTEMS

(71) Applicant: ClearMotion, Inc., Billerica, MA (US)

(72) Inventors: Marco Giovanardi, Melrose, MA (US); William Graves, Somerville, MA (US); Allen Chung-Hao Chen, San Jose, CA (US)

(73) Assignee: ClearMotion, Inc., Billerica, MA (US)

(21) Appl. No.: 17/787,679

(22) PCT Filed: Dec. 30, 2020
(86) PCT No.: PCT/US2020/067479

§ 371 Date: Jun. 21, 2022

Related U.S. Application Data
(60) Provisional application No. 62/954,982, filed on Dec. 30, 2019.

(51) Int. Cl. B60G 17/0165; B60G 17/018; B60W 40/06; B60W 10/22

(52) U.S. Cl. CPC B60G 17/0165; B60G 17/0182; B60W 40/06; B60W 10/22; B60G 2400/82; B60G 2600/60; B60G 2600/1875; B60G 2400/91; B60G 2204/45

(57) ABSTRACT

Methods are provided for proactively controlling a component of a system. The system may comprise a vehicle and the component may comprise a suspension of the vehicle. According to various aspects, methods may include obtaining information regarding a travel surface along a travel path that the system will travel at a future time and, based on the information regarding the travel surface, controlling the component of the system to traverse the travel surface. Controlling the component based on the information regarding the travel surface may comprise comparing the information regarding the travel surface to information regarding at least one physical constraint of the system and/or comparing frequency content of the information regarding the travel surface to a threshold frequency. Proactive control methods may provide improved response to disturbances and improved tracking and isolation because a suspension may be controlled with reduced or substantially zero delay.

### RELATED APPLICATIONS

This application claims priority to U.S. Provisional Application Ser. No. 62/954,982, titled “PROACTIVE CONTROL OF VEHICLE SYSTEMS,” filed on Dec. 30, 2019, which is herein incorporated by reference in its entirety.

### BACKGROUND

A system, such as a vehicle, may have a suspension that provides a response to inputs to the system from a travel surface upon which the system is traveling. For example, an input from a travel surface may be a bump in a road. Conventional systems may have passive or active suspensions that react to inputs from the travel surface as they are input.

### BRIEF SUMMARY

According to aspects of the disclosure, there is provided a method comprising obtaining information regarding a travel surface along a travel path that a system will travel at a future time and, based on the information regarding the travel surface, controlling at least one component of the system to traverse the travel surface. Controlling the at least one component based on the information regarding the travel surface comprises comparing the information regarding the travel surface to information regarding at least one physical constraint of the system and controlling the at least one component of the system based on at least one setpoint related to a result of the comparing.

In some embodiments, controlling the at least one component of the system based on the at least one setpoint related to a result of the comparing the information regarding the travel surface to information regarding at least one physical constraint of the system comprises, when a first magnitude associated with the information regarding the travel surface is less than a threshold magnitude, applying a first filter having a first filter frequency and when a second magnitude associated with the information regarding the travel surface is greater than the threshold magnitude, applying a second filter having a second filter frequency, the second filter frequency being greater than the first filter frequency.

In some embodiments, the system is an automobile and controlling the at least one component of the system to traverse the travel surface comprises controlling at least one component of the automobile to traverse the travel surface.

In some embodiments, the at least one component comprises a suspension of the automobile and the at least one physical constraint of the system comprises a travel limit of the suspension.

In some embodiments, controlling the at least one component based on the information regarding the travel surface further comprises, based on the information regarding the travel surface, determining an expected signal of a sensor of the system in response to detection of the travel surface while the system is traversing the travel surface and, while the system is traversing the travel surface at the future time, additionally controlling the at least one component of the system based on the expected signal of the sensor and a signal output by the sensor in response to detection of the travel surface while the system is traversing the travel surface.

In some embodiments, the method further comprises, at a time prior to the obtaining, capturing the information regarding the travel surface along the travel path.

In some embodiments, the information regarding the travel surface along the travel path comprises a topography of a road surface.

In some embodiments controlling the at least one component based on the information regarding the travel surface further comprises applying a zero-phase filter to the information regarding the travel surface along the travel path.

In some embodiments, controlling the at least one component of the system based on at least one setpoint comprises controlling the at least one component of the system based on at least one frequency, gain, or calibration factor.

According to aspects of the disclosure, there is provided at least one computer-readable storage medium having encoded thereon executable instructions that, when executed by at least one controller, cause the at least one controller to carry out the method of any one or any combination of the foregoing embodiments.

According to aspects of the disclosure, there is provided a system comprising at least one controller. The at least one controller is configured to execute a method comprising obtaining information regarding a travel surface along a travel path that the system will travel at a future time and, based on the information regarding the travel surface, controlling at least one component of the system to traverse the travel surface. Controlling the at least one component based on the information regarding the travel surface comprises comparing the information regarding the travel system to information regarding at least one physical constraint of the system and controlling the at least one component of the system based on at least one frequency related to a result of the comparing.

In some embodiments, comparing the information regarding the travel surface to information regarding at least one physical constraint of the system comprises when a first magnitude associated with the information regarding the travel surface is less than a threshold magnitude, applying a first filter having a first filter frequency and when a second magnitude associated with the information regarding the travel surface is greater than the threshold magnitude, applying a second filter having a second filter frequency, the second filter frequency being greater than the first filter frequency.

In some embodiments, the system is an automobile and controlling the at least one component of the system to traverse the travel surface comprises controlling at least one component of the automobile to traverse the travel surface.

In some embodiments, the at least one component comprises a suspension of the automobile and the at least one physical constraint of the system comprises a travel limit of the suspension.

In some embodiments, controlling the at least one component based on the information regarding the travel surface further comprises applying a zero-phase filter to the information regarding the travel surface along the travel path

According to aspects of the disclosure, there is provided a method comprising obtaining information regarding a travel surface along a travel path that a system will travel at a future time and, based on the information regarding the travel surface, controlling at least one component of the system to traverse the travel surface. Controlling the at least one component based on the information regarding the travel surface comprises comparing frequency content of the information regarding the travel surface to a threshold frequency and controlling the at least one component of the system based on a result of the comparing.

In some embodiments, controlling the at least one component based on the information regarding the travel surface further comprises when the frequency content is below a threshold frequency, controlling the at least one component of the system to track the frequency content, and when the frequency content is above the threshold frequency, controlling the at least one component of the system to isolate the frequency content.

In some embodiments, the system is an automobile and controlling the at least one component of the system to traverse the travel surface comprises controlling at least one component of the automobile to traverse the travel surface.

In some embodiments, the at least one component comprises a suspension of the automobile.

In some embodiments, the method further comprises, at a past time, capturing the information regarding the travel surface along the travel path.

In some embodiments, the information regarding the travel surface along the travel path comprises a topography of a road surface.

In some embodiments, controlling the at least one component based on the information regarding the travel surface further comprises applying a zero-phase filter to the information regarding the travel surface along the travel path.

### BRIEF DESCRIPTION OF DRAWINGS

FIG. 1A is a schematic representation of one embodiment of a vehicle;

FIG. 1B is a schematic representation of one embodiment of a processor configured to control one or more active and/or semi-active systems of a vehicle;

FIG. 2 is a flow diagram of one embodiment of a method related to proactive control of vehicle systems;

FIG. 3 is a flow diagram of one embodiment of a method related to controlling at least one component of a system based on information regarding the travel surface;

FIG. 4 is a flow diagram of one embodiment of a method related to controlling at least one component of a system based on information regarding the travel surface;

FIG. 5 is a flow diagram of one embodiment of a method related to comparing information regarding a travel surface to information regarding at least one physical constraint of a system;

FIG. 6 is a flow diagram of one embodiment of a method related to controlling at least one component of a system based on information regarding a travel surface;

FIG. 7 shows one embodiment of a step response of a quarter car model;

FIG. 8 shows one embodiment of a feedback control loop;

FIG. 9 shows one embodiment of an effect of zero-phase filtering;

FIG. 10 shows one embodiment of a trajectory planning schematic;

FIG. 11 shows one embodiment of zero-phase filtering at lower and higher frequency;

FIG. 12 shows one embodiment of an effect of a time-varying filter;

FIG. 13 shows one embodiment of a layout of a proactive control block in a feedback loop;

FIG. 14 shows one embodiment of content of a proactive control calculation block;

FIG. 15 shows one embodiment of a quarter car model;

FIG. 16 shows one embodiment of tracking and isolation filters and their combination;

FIG. 17 shows one embodiment of reduced performance tracking and isolation and their combination;

FIG. 18 shows one embodiment of details of proactive control command calculation;

FIG. 19 shows one embodiment of ratios of body acceleration with and without proactive control enabled;

FIG. 20 shows one embodiment of ratios of suspension position with and without proactive control enabled;

FIG. 21 shows one embodiment of a vehicle suspension control architecture; and

FIG. 22 shows one embodiment of control architecture with proactive control integration.

### DETAILED DESCRIPTION

According to various aspects of the disclosure, methods are provided for proactively controlling one or more components of a system. In some embodiments, the system comprises a vehicle and the component includes a component of the vehicle, such as a suspension of the vehicle or other examples of vehicle components discussed below. In some embodiments, the methods may include obtaining a priori information related to a travel surface of a travel path that the system is to travel and controlling the component of the system using the a priori information related to the travel surface.

According to various aspects of the disclosure, controlling the component based on the a priori information related to the travel surface may include comparing the a priori information related to the travel surface to information related to one or more physical constraints of the system and controlling the component based on a setpoint related to a result of the comparing. In some embodiments, such a setpoint may be a frequency, gain, or calibration factor.

The physical constraint of the system may be a physical constraint of a component of the system, which is to be controlled. For example, where a component to be controlled is a suspension of a vehicle, the physical constraint of the system may be a travel limit of the suspension. The travel limit of a suspension may be the vertical distance the suspension is able to travel between its most compressed and most expanded positions. A priori information related to a travel surface may include information related to a topography of a travel surface, such as roughness characteristics of the travel surface including convex and/or concave features of the travel surface. Where the travel surface is a surface of a road (e.g., asphalt road, dirt road, or other road) that a vehicle is being operated on or is to be operated on, the convex and/or concave features of the travel surface may include depressions, bumps, potholes, or other information regarding features of the road that may cause a vertical position of the road surface at a point to be above or below an average vertical position of the road surface at preceding and/or following points along the road surface (e.g., average over three feet, five feet, ten feet, twenty feet, or other suitable distance). A priori information regarding such topography of the travel surface, such as vertical features of the travel surface, may be compared to physical constraints like the travel limit of the suspension to determine how to operate components like a suspension, in accordance with techniques described herein.

As mentioned above and as described in detail below, controlling the component(s) of the system based on the a priori information may include controlling the component(s) based on a setpoint related to a result of the comparing of the information regarding the travel surface to the information regarding the physical constraint(s) of the system, such as a physical constraint of a system component to be controlled. In some embodiments, such a comparison may include comparing information regarding the travel surface to one or more thresholds related to the physical constraint, and identifying a setpoint based on the result. In some embodiments, including examples described below, this setpoint may be a frequency setpoint. Examples of ways in which this frequency is used are described below. As one example, when a first magnitude of information related to the travel surface is less than a threshold magnitude, a filter having a first frequency may be applied and when a second magnitude of information related to the travel surface is greater than the threshold magnitude, a filter having a second frequency may be applied. The second frequency may be greater than the first frequency. The filter with the identified frequency may be applied, in some cases, to at least some of the information relating to the travel surface, and a result of the filtering may be used in control of the component(s).

By proactively controlling one or more components using a priori information regarding the travel surface, a system may be able to increase compliance with or better achieve one or more objectives related to operation of the component(s) or travel by the system. For example, where the component to be controlled is a suspension, an objective related to operation of the suspension or vehicle may be limiting the number and/or magnitude (and/or other suitable characteristics) of vertical, roll, or pitch movements of the vehicle body that are perceived by the vehicle occupants. Accordingly, in some embodiments in which a suspension is controlled based on applying filters with different frequencies to information regarding the travel surface, a suspension may provide passengers of the vehicle with improved comfort when travelling over smaller disturbances while ensuring that travel limits of the suspension are not exceeded when travelling over larger disturbances.

A proactive controller may be advantageous in some scenarios because use of advance information regarding the travel surface may allow for operation of a component in a manner that accounts for conditions of a travel surface prior to arrival of the system at a particular feature of the travel surface (e.g., a pothole of a road) or prior to detection of the particular feature with one or more sensors or other detection components of the system. This can provide improved response to such disturbances because a component of the system may be controlled with reduced or substantially zero delay, as compared to reactive systems that control components only in response to arrival at or detection of the disturbance.

According to some aspects of the disclosure, controlling the component based on a priori information related to the travel surface may include comparing frequency content of a priori information related to the travel surface to a threshold frequency and controlling the component based on a result of the comparing.

For example, when content within a first frequency range of travel surface information is below a threshold frequency, the component may be controlled to track the travel surface and when the content within that first frequency range is above the threshold frequency, the component may be controlled to isolate the travel surface features indicated by the content information by operating one or more components in a manner that compensates for the features.

Tracking low frequency inputs of a travel surface may in some cases provide a driver of a vehicle with an improved perception that the vehicle is in control. Isolating high frequency inputs of a travel surface may in some cases provide passengers of the vehicle improved comfort. A proactive controller may provide improved tracking and isolation because a suspension may be controlled with reduced or substantially zero delay.

According to some embodiments, a controller may provide reduced or substantially zero delay for providing improved response to disturbances or for providing improved tracking and isolation by using a zero-phase filter. A zero-phase filter may leverage a priori knowledge of a travel surface. In some embodiments, a priori knowledge of a travel surface may be collected during a previous trip over the travel surface.

Systems such as road vehicles may include controllers that control aspects of the system's response to travel surface inputs. A travel surface may comprise a surface along a travel path of a system, such as a road or factory floor. Controllers may be limited in their performance by their response time, because conventional controllers respond to environmental inputs (for example, road inputs such as road induced disturbances and/or vehicle dynamics) after those inputs have been sensed, and only then respond with a characteristic system response time. Responsive control may lead to subpar performance. The inventors have recognized that such performance may not be improved by conventional means.

The inventors have further recognized that a priori knowledge of a travel surface, such as a road, may be used to improve the performance of one or more systems of a vehicle. For example, a priori knowledge of a travel surface may include information regarding a portion of the travel surface along a travel path that a system has not yet traveled and will travel at a future time, and that is obtained by the system in advance of that future time. The future time may be a duration of time following a current time, such as one second following a current time, three seconds following a current time, five seconds following a current time, ten seconds following a current time, twenty seconds following a current time, or other amount of time following a current time. The future time may additionally or alternatively be such a duration of time starting following some set amount of time in the future (rather than starting at the current time), where the amount of time in the future at which the duration starts may be one second in the future, three seconds in the future, five seconds in the future, ten seconds in the future, twenty seconds in the future, or other amount of time. In some embodiments, the duration of time and/or the start time may vary based on operation of the system, such as varying based on an operating speed of the system. In some embodiments, a priori knowledge of a travel surface may include information regarding a portion of the travel surface in front of a leading wheel of a vehicle, in a direction of motion of the vehicle.

A priori information regarding a travel surface may be obtained by a system from one or more data stores of travel surface information. In some embodiments, a priori information stored in the data store may be based on data from a crowd-sourced road mapping system, and/or from, as non-limiting examples: a camera or other visual sensor, an interference-based sensor such as laser, radar, Lidar, ground-penetrating radar, echolocation, or any combination of such sensors or technologies. A travel surface ahead of a system may be known from previous mapping, such as during previous trips of the system or previous trips of other similar systems, using satellite imagery, or using travel surface scanning tools. The inventors have recognized that when aspects of the a travel surface ahead of a system are known, and when the system can be localized on the travel surface, performance of controlled systems, such as, for example, feedback controller of the system, may be improved.

Various types of components may be controlled, based on advance knowledge of a travel system, using techniques described herein. In some embodiments, components of a system that are controlled may include, as non-limiting examples, one or more of: active and semi-active vehicle and/or seat suspension systems; cab suspensions; payload suspension systems of, for example, ambulances or sleeper beds or payload storage systems; anti-lock brakes; stability control; and autonomous driving systems such as steering systems, lane keeping systems, and active braking systems.

In some embodiments, a system that traverses a travel surface (for example, a road surface or track) may be a wheeled vehicle (for example, a passenger car or van, a utility vehicle such as a dump truck, a tractor or earth mover), a tracked vehicle (for example, a tank or earth mover), or a rail vehicle. It should be appreciated that embodiments are not limited to operating with a particular form of system that follows a travel path or, when the system is a vehicle, a particular type of vehicle. According to some aspects of the disclosure, the systems described may be used in automation and robotics environments, where autonomous or semi-autonomous systems traverse sections of an area repeatedly. For example, the systems described may be used with automation robots in warehouses or manufacturing facilities, or with industrial robots that move from place to place.

In some examples described below, for ease of description, a system is described as a vehicle, a travel surface is a road surface on which the vehicle will travel, and a component to be controlled based on advance information regarding the travel surface is a suspension of the vehicle. It should be appreciated, however, that embodiments are not limited to operation with these specific examples.

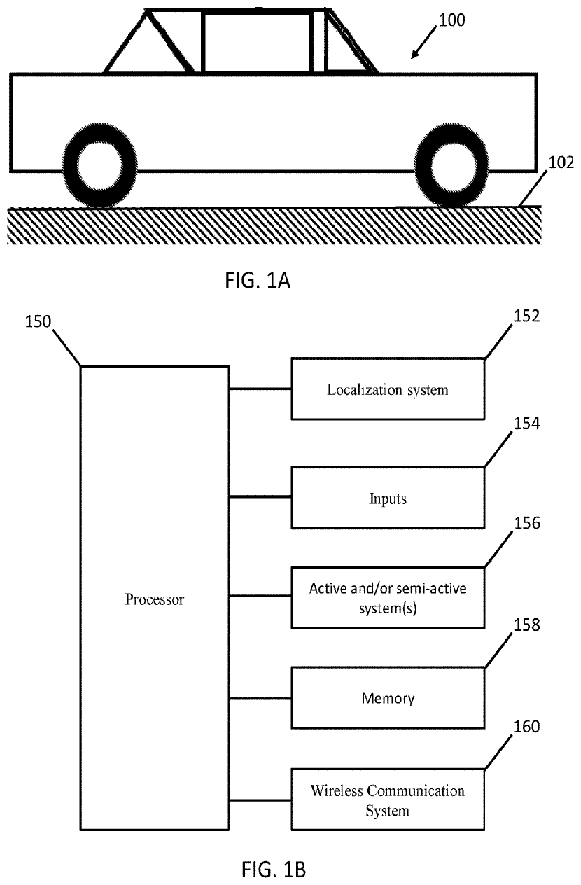

FIG. 1A depicts a system 100 traversing a travel surface 102 that may include one or more travel surface features along its length. In some embodiments, the system 100 may comprise a vehicle such as an automobile. Travel surface features, as mentioned above, may include features that relate to a topography of a travel surface, such as convex and/or concave features of a travel surface or other features that cause a vertical position of a travel surface at a point to be above or below an average vertical position of the travel surface at preceding and/or following points along the road surface (e.g., average over three feet, five feet, ten feet, twenty feet, or other suitable distance). In some embodiments, travel surface 102 may comprise a road surface of a road, such as a road made of dirt, asphalt, or other suitable road material. Where a travel surface is a road surface, travel surface features may include depressions, bumps, potholes, or other road surface characteristics such as roughness characteristics.

System 100 may include various sensors and control systems, as depicted in FIG. 1B. As shown in FIG. 1B, a system may include one or more processors, such as the depicted processor 150. The processor 150 may be operatively coupled with a localization system 152, one or more inputs 154, one or more active and/or semi-active systems 156, non-transitory processor readable memory 158, or a wireless communication system 160.

According to various embodiments, processor 150 may be a central processor of the system, one or more processors associated with a particular active and/or semi-active system, combinations of the foregoing, and/or any other appropriate processor as the disclosure is not limited to a location of where a processor used to execute the disclosed methods is located.

In some embodiments, localization system 152 may comprise GPS systems, terrain-based localization systems, and/or any other appropriate localization system capable of providing a location of a vehicle on a road surface to the processor 150.

In some embodiments, inputs 154 to the processor 150 may include sensor inputs and/or inputs from various systems of a vehicle which may include, a velocimeter output of a vehicle, a velocity sensor, shaft encoders, steering inputs, braking inputs, and/or any other appropriate type of input from a sensor or system included in a vehicle.

In embodiments where information, such as a buffered roadmap, is communicated to a vehicle, the wireless communication system 160 may transmit information between the processor 150 and one or more remote databases and/or servers.

The memory 158 associated with the one or more processors may include processor executable instructions that when executed cause the processor 150 and the associated systems to perform any of the methods described herein.

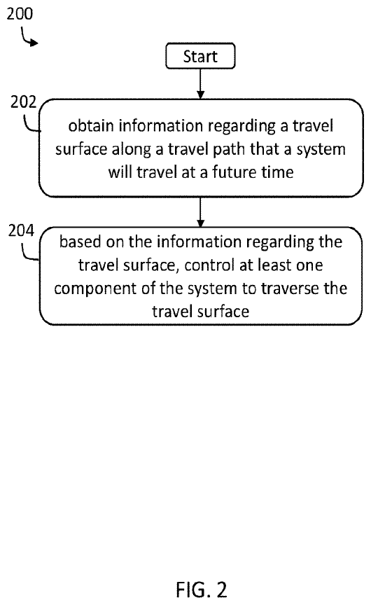

FIG. 2 shows a process flow 200 of one embodiment of a method related to proactive control of vehicle systems. The process flow 200 may be performed by a controller of a system, such as processor 150 of the example of FIG. 1B. Process flow 200 comprises step 202 and step 204. In step 202, the controller obtains information regarding a travel surface along a travel path that a system will travel at a future time. In step 204, based on the information regarding the travel surface, the controller controls one or more components of the system to traverse the travel surface.

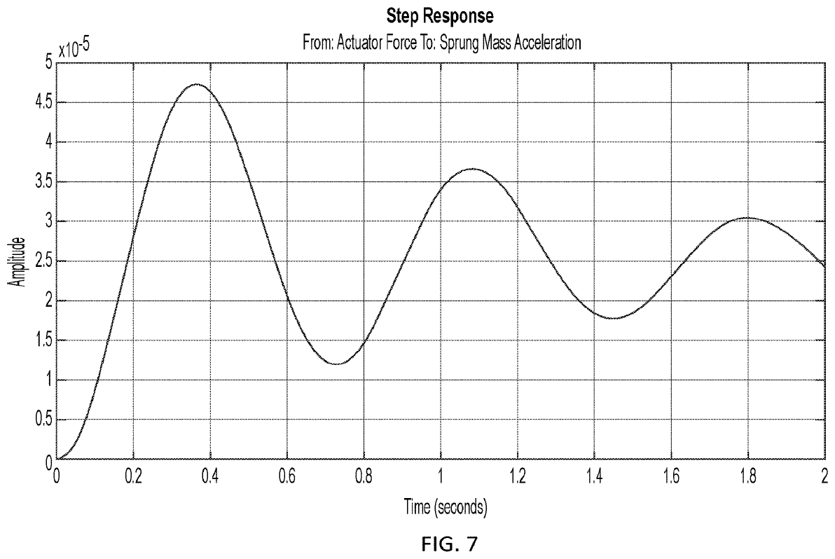

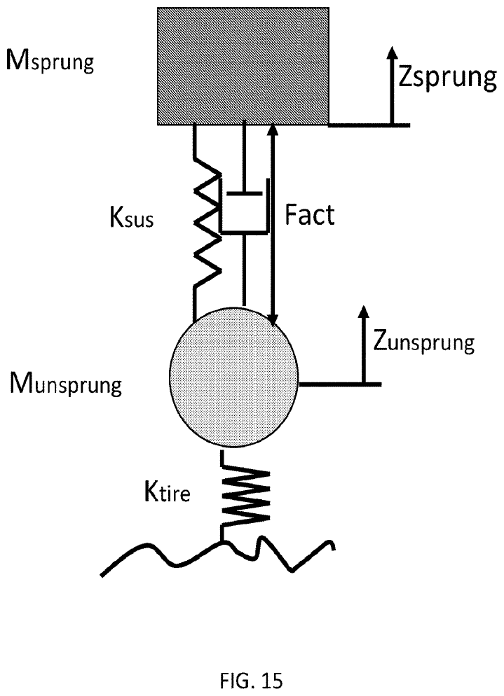

A causal controller operating in real time may be constrained because it is causal. For example, a causal controller may be causal when the causal controller can only react to things that have happened once it has sensed them. Causal control imposes a limitation on the performance of a causal controller due to the limitations of the physical systems it operates on or with. A quarter car model (such as illustrated in FIG. 15) may include an unsprung mass, a sprung mass, and a suspension system between the unsprung mass and sprung mass. A quarter car model may be used to model or demonstrate a response of a suspension system. For example, FIG. 7 relates to a quarter car model and shows a response of a sprung mass of the quarter car model to a step input in force.

As shown in FIG. 7, in some embodiments of a causal controller, once a vehicle receives an actuator force command, there is a delay before it responds. The delay means that there is a lag in the response. The delay may determine or be determined by a highest frequency at which the system can operate, which may limit performance of the causal controller.

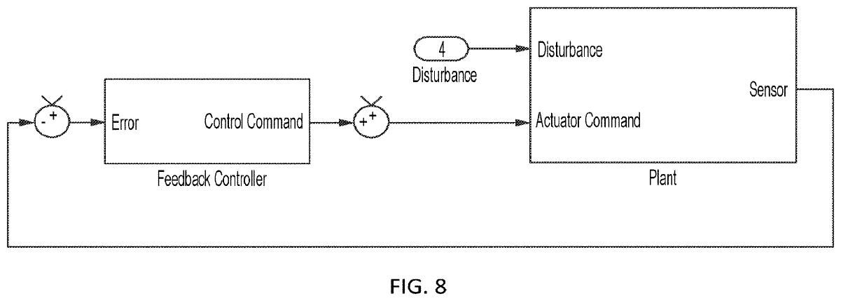

In some embodiments, a conventional causal controller may have the structure shown in FIG. 8. A plant (shown in dark gray, which may correspond to the vehicle in the example above) responds to control inputs from one or more actuators, and to one or more disturbance inputs (for example from a travel surface). In some embodiments, one or more sensors may be used to detect changes in relevant parameters that are to be controlled. For example, one of the vehicle parameters may be measured or related to sprung mass motion. Subtracting sensor output from a desired state value results in an error signal that may be an input to the controller. The controller may then calculate the improved response and accordingly command the actuator.

The architecture shown in FIG. 8 is functionally similar to an architecture where a controller block is placed in the feedback path. In some embodiments, a controller of the type of architecture shown in FIG. 8 may be a skyhook controller for ride control in a vehicle suspension.

A proactive controller may comprise a controller that utilizes pre-emptive (for example, acausal or anti-causal) information in an algorithm. Acausal information may comprise information that is not caused by events that are happening in real-time, and/or is predictive of future inputs.

According to aspects of the disclosure, an exemplary proactive controller may comprise a controller that uses a priori knowledge of upcoming inputs. In some embodiments, a proactive controller may be provided a priori knowledge of a travel surface, such as a road profile, ahead of the system.

In some embodiments, a travel surface may comprise a road surface. In some embodiments, a road profile comprises information regarding characteristics of a road surface. For example, a road profile may comprise information regarding a topography of the road surface, changes in elevation of a road; size and location of discontinuities in a road surface, such as, cracks, potholes, manhole covers, or other abrupt changes in the z or vertical direction; radius and location of turns; a number of lanes.

A road profile may be used directly or indirectly to control a system on a vehicle. For example, a road profile may be used to control a vehicle chassis control system such as an active or semi-active suspension system, a seat active suspension system, a braking system, a steering system. In some embodiments of a proactive controller, a road profile of a given road may be recorded during a first trip, and then used as an input to the proactive controller during a subsequent trip on the same road. An advantage from this a priori knowledge may be to increase the performance, for example, response, of the system.

As described above, the performance of a causal controller may be limited at least in part by the response time of the causal controller. For such a conventional causal controller, a phase response of the system may roll off (which may be functionally equivalent to a delay), resulting in an upper limit to stability of the feedback loop. When filtering a signal, for example when calculating a control signal by applying a filter to an error signal, a phase response of the filter affects the phase of the resulting command.

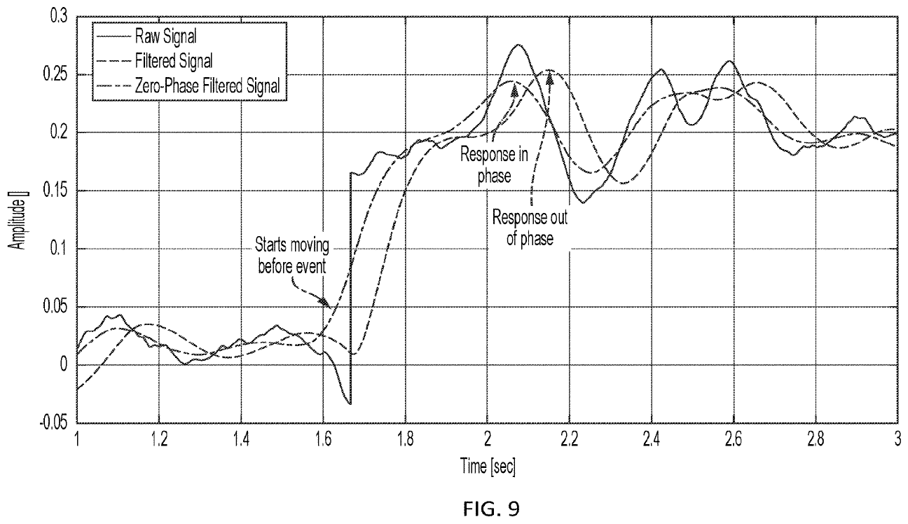

According to aspects of the disclosure, mathematically, it is possible to filter a signal with a zero-phase filter. A zero-phase filter may comprise a non-causal filter. A zero-phase filter may not be able to be applied in real time. For example, a zero-phase filter may require a priori knowledge of an input signal. In some embodiments, a zero-phase filter may be applied to an entire signal during post-processing. For example, in signal processing, applying a zero-phase filter may be achieved by applying a filter first in a forward direction on an input signal, and then applying the same filter backward on the result (for example, by inverting an order in time of at least a part of the input and filtering it, then inverting the order back). A resulting filtered signal may be compared with the raw data, and with a signal that was processed through a causal filter of the same magnitude (meaning, a filter that is applied only in the forward direction, but that has a magnitude effect that is the same as the total result of the filter applied in both directions). FIG. 9 shows an exemplary results of both a causal filter and a zero-phase filter on a given input signal.

FIG. 9 shows that while the causal filter creates a delayed response to the raw signal, the zero-phase filter does not, thus improving performance, such as response time. In order to achieve the improved performance, it may be necessary for the zero-phase filter to act before an event occurs, or in other words, receive information regarding the event before it actually happens, and thus be acausal.

With a priori knowledge of an upcoming disturbance in a system, zero-phase filtering may be applied to the disturbance, and the resulting control system may be able to achieve improved performance, such as improved response time. As explained above, overall controller gain may be limited by the phase of the loop gain of the system, and therefore the ability to apply a control filter with no added phase may allow controller gains to be increased, thus improving performance. For example, proactive control may allow delay of a response to be reduced, and therefore allow a magnitude of the response to be increased. Reduced response delay and increased response magnitude may improve performance because a disturbance may be attenuated quicker.

According to various embodiments, a priori knowledge of an event does not have to extend indefinitely far into the future. For example, in some embodiments, when the relevant dynamics of a system and a controller, such as the body resonance on the suspension in the case of a road vehicle, are most significant around 1 Hz, then a knowledge of multiple seconds' (for example, between about 2 and 8, or about 5 seconds) worth of upcoming disturbance may allow the controller to respond to and attenuate the disturbance. The relevant dynamics may in some embodiments be the dynamics that most affect the performance of the system, for example the overall comfort of the occupants in a vehicle, or the traction between the tires and the road in a road vehicle. The inventors have recognized that when the length of preview time is related to the frequency of the most relevant dynamics of the system comprised of the plant to be controlled, and the actuators used to control it, a length of preview time can be determined that provides a significant benefit to the control system without needing to be indefinitely long.

In some such cases, this preview time may be a lowest preview time to achieve a desired goal, such as a desired effect on control of the system. Longer preview time may be helpful in performing advance or just-in-time control of a component of a system based on upcoming features of a travel surface. Those skilled in the art may appreciate that while longer preview time may be helpful, there may be diminishing returns as a preview time extends farther and farther into the future, such that an overly lengthy preview time may not be tangibly beneficial. Moreover, in some cases, a view of a travel surface that a system is predicted to travel may not be a surface that a system is certain to travel. There may be uncertainty in predicting movements of a system, such as movements of a vehicle under manual operation by a human who may change a route. As a preview time extends farther into the future, that uncertainty may increase. A controller may be able to predict with a higher certainty a travel path that a system will travel in three, five, or ten seconds than a travel path that a system will travel in five, 10, or 30 minutes. Accordingly, techniques described herein may be used to determine a length of a preview time that may have advantageous effects, which may set a lower end of a preview time in some embodiments.

In some embodiments, a length of a preview time may be determined based on frequency dynamics of the system (such as a vehicle). In some embodiments, frequency dynamics of a system may include primary modes of vibration of the system and/or may include resonant modes of vibration of the system. In some embodiments, the modes may relate to comfort of passengers in a vehicle, such as by relating to the passengers' perception of the vibration, bounciness, or other motion of the vehicle. The modes may relate to frequencies or frequency ranges.

In some embodiments, a preview time may be determined to be at least as long as a multiple (e.g., 1×, 2×, 3×, etc.) of a period corresponding to a frequency of interest, such as a frequency dynamic of the system (e.g., a vibration mode of the system). The frequency of interest may be, in some embodiments, a lowest frequency of interest. According to one exemplary embodiment, a group of one or more frequency modes may be identified through analysis of the system, such as by analyzing movements of the system or responses of the system to outside stimulus. The analysis may be related to one or more components of the system. For example, where a system is a vehicle, the analysis may include analysis of one or more vibration modes of a component of the system that controls movement of a body of the system relative to a travel surface. Where the vehicle is a car or other automobile, the component may be a suspension of the vehicle that controls how a body of the automobile moves relative to a travel surface (e.g., a road surface). A mode of interest may be determined by identifying a mode having a magnitude above a threshold magnitude. The magnitude may be a magnitude of an effect of the mode on movement of the vehicle. Frequencies associated with the modes of interest may next be identified. The modes of interest may be ranked by frequency. Next, a lowest frequency associated with the modes of interest may be identified. Then, a period corresponding to the inverse of the lowest frequency may be identified. According to the exemplary embodiment, the preview time may then be identified to be at least as long as a multiple of the period corresponding to the inverse of the lowest of the selected vibration mode frequencies.

In some embodiments for example, the length of preview time may be set to a value that is at least 5 times an inverse of the frequency of the relevant dynamics (e.g., one or more vibration mode frequencies) that are to be operated on. In some embodiments, less preview time may be required, for example, a duration longer than 3 or 4 times the inverse of the frequency of the relevant dynamics may be used with reduced performance, such as increased response time. According to various embodiments, other durations of preview time, longer or shorter than those noted above, may be used as the disclosure is not so limited.

In some embodiments, a length of the preview time may be identified based on tradeoffs between controller performance and other factors. For example, when a longer preview time is selected, the controller may be required to perform greater processing, for example, because the controller is determining control signals to be applied over a longer time period into the future. Additionally, when a longer preview time is selected, greater uncertainty may be introduced into the processing, for example, because a controller may be uncertain about the exact travel path that will be taken by the system over the longer preview time. For example, the controller may not know in advance that a driver of a vehicle will take a turn onto another road.

In some embodiments, processing information from a preview time greater than several multiples of the period corresponding to modes of interest may not necessarily provide performance increases. For example, if a controller can use a 5 time multiple of the period corresponding to a mode of interest to attenuate dynamics of that mode, providing the controller with additional preview time may not necessarily increase controller performance, because only the 5 time multiple is needed to provide control signals soon enough to attenuate that mode.

In some embodiments, a length of preview time may be calculated and set by a controller during operation of a system along a travel path. In other embodiments, a length of preview time may be calculated in advance based on known properties of the system and/or one or more components of the system, such as by being calculated by a user or manager of the system or of the controller prior to operation of the system along a travel path. In this latter case, the controller may be configured with the calculated length of preview time, such as by storing the calculated length in a storage.

In some embodiments, a further advantage of proactive control may be the ability to predict one or more characteristics of a disturbance input that is about to be encountered, and to consider certain system physical limits in order to select an appropriate control strategy. A controller may store information regarding physical limits of a system. The physical limits may be provided to the controller as preset information, and/or a controller may determine or update physical limits by collecting information related to physical limits when the system is in use.

For example, physical limits of a system may include actuator limits such as damper stroke limits, power limits, or velocity limits, or system limits such as relationships between motions of various actuators connected to the system. For example, in a suspension system, each wheel may only be able to move a certain amount before interfering with other components, such as, the vehicle fender, or the vehicle frame, or before a tire interferes with chassis components. In some embodiments, travel limits may be imposed on the suspension by mechanical and controls requirements. For example, a system limit may be the fact that the 4 wheels in a typical road vehicle are linked through the chassis. Therefore, while in common mode front or rear, or in roll, the vehicle can “get out of the way” of the suspension when encountering an obstacle, it cannot do so in twist or warp. For example, when encountering an obstacle such as an angled ramp where two opposite wheels (for example the front left and the rear right) need to move toward the vehicle in order to absorb the obstacle, then the absence of rigid vehicle motion may improve comfort. On the other hand, if an obstacle is encountered in common mode (such as for example a speedbump), the vehicle body may follow the contour of the road and thus not reduce suspension motion and increase comfort.

In some embodiments, information about one or more physical limitations of a system, and with a priori knowledge of the upcoming disturbance, the disturbance may be tested against a model of the system. In this way it may be possible to predict if any constraints or limitations will be violated. In some embodiments, an improved path for a portion of the vehicle (e.g. the vehicle body, an active seat, a suspension component) may be calculated in order to not violate any constraints while maintaining improved performance.

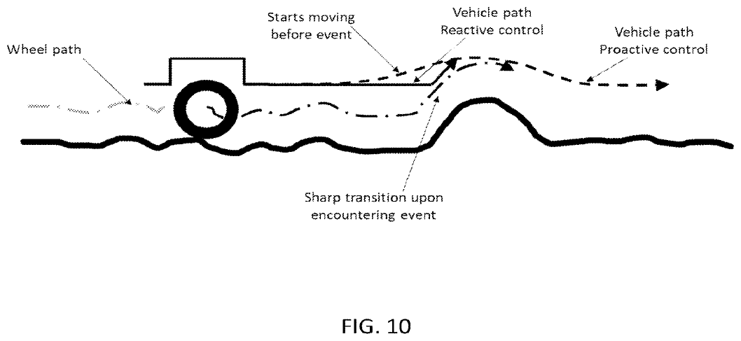

FIG. 10 shows an exemplary schematic representation of an embodiment of a suspension system traversing a road with small and large undulations. One constraint for a suspension system may be a limit in the travel stroke of the actuator or the suspension in general. For example, the suspension may be able to absorb bumps of a certain size without the body suspended above it (the vehicle body for example) having to move in the vertical direction. However, for road inputs that exceed a certain size, the suspension may not be able to completely absorb the input without the vehicle moving in the vertical direction.

In the embodiment illustrated in FIG. 10, the amount of travel the suspension absorbs is the difference between the wheel path and the path of the vehicle body, for example, because the suspension is the element that is interposed between them. As discussed below, the difference between the disturbance (for example, the road contour, since the wheel path closely follows it) and the vehicle body motion may be used as a metric for suspension travel constraint.

With a proactive suspension controller, a priori knowledge of upcoming events allows planning and/or selecting an improved trajectory for the vehicle that reduces or substantially minimizes negative effects, such as, for example, road induced jerk input into a vehicle, which may negatively affect the comfort of vehicle occupants. Without a priori knowledge, suspension tuning may require compromise that may adversely affect overall performance over other road events, including small ones. FIG. 10 shows the path that the vehicle body would take in the case of a reactive suspension (meaning, a suspension without a priori knowledge of upcoming disturbances), which would incur a sharp transition when encountering a large event. Sharp transitions may be handled with algorithms that control travel, such as end-of-travel algorithms, but these may not perform well without also compromising performance on smaller bumps. FIG. 10 also shows the path a vehicle with proactive suspension may be able to take, where the improved trajectory may require the suspension to start moving the vehicle body before the constraint event happens. Because the suspension starts moving before the constraint event, the suspension control may be acausal from the event's point of view.

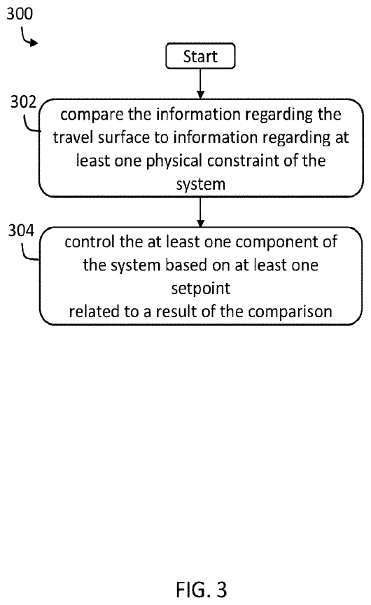

FIG. 3 shows a process flow 300 of one embodiment of a method related to controlling at least one component of a system based on information regarding a travel surface. The process flow 300 may be performed by a controller of a system, such as processor 150 of the example of FIG. 1B, based on a priori travel surface information received by the controller and information available to the controller about one or more physical constraints of the system. Process flow 300 comprises step 302 and step 304. In step 302, the controller compares the information regarding a travel surface to information regarding at least one physical constraint of the system. In step 304, the controller controls at least one component of the system based on at least one setpoint related to a result of the comparison.

A setpoint, for example a frequency, gain, or calibration factor, related to the result of the comparison may be used by the controller in a variety of ways, including in controlling a component of a system and/or preparing data (e.g., travel surface information) for control of the component. In some embodiments, for example, through the comparison of travel surface information to at least one physical constraint of the system the controller may identify a frequency to be used in a filter that the controller applies to travel surface information. Using different frequencies in filters may result in advantageous control of a component, as described below.

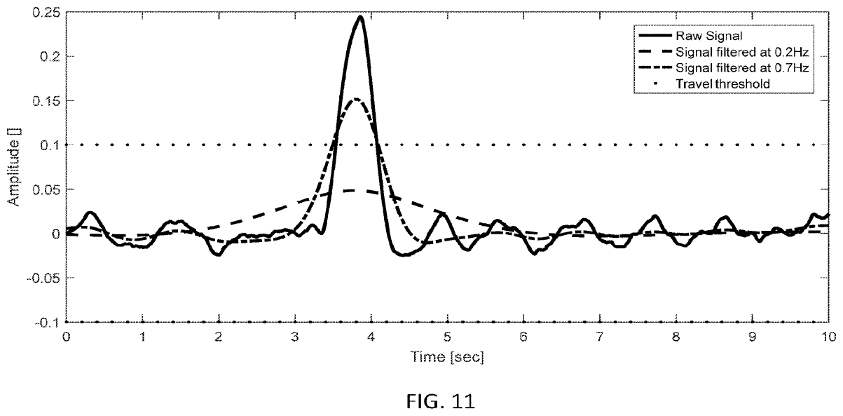

FIG. 11 shows the difference between an embodiment with a more aggressive and an embodiment with a less aggressive strategy for following the trajectory imposed by the disturbance. A trajectory imposed by a disturbance may include, for example, an upward trajectory for an upward deviation in a travel surface (e.g., a speed bump on a road surface) or a downward trajectory for a downward deviation in a travel surface (e.g., a pothole in a road surface). A more “aggressive” strategy may more closely follow the trajectory of the disturbance while a less “aggressive” strategy may not follow the trajectory of the disturbance as closely. If for example the physical limit of suspension travel is 0.1 m, and the suspension travel was assumed to be equivalent to the difference between the disturbance (which may be equivalent to the wheel path) and the trajectory (which represents the desired motion of the vehicle), then FIG. 11 demonstrates that while the less aggressive scheme does a better job at isolating the smaller events, it is not suitable in order to keep the suspension travel below 0.1 m. The more aggressive filter on the other hand may maintain suspension travel within the suspension travel limit at all times in this example, but does not deliver improved performance (for example, reduced movement of the vehicle body) over smaller events.

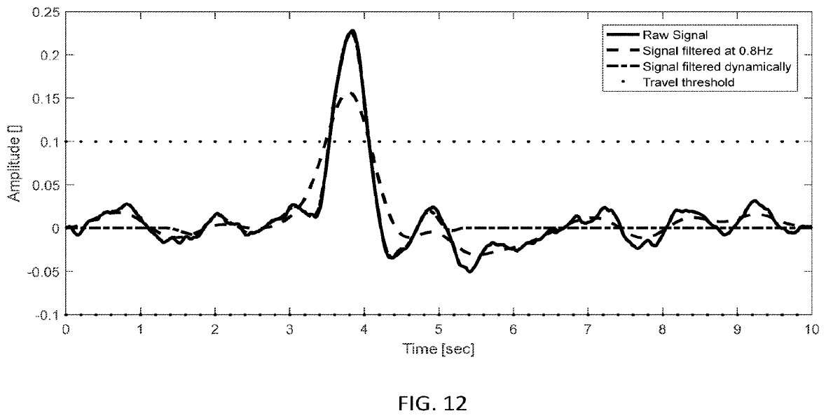

An improved trajectory may be calculated in various ways. For example, one way to calculate an improved trajectory may be to apply a time-varying low-pass filter to the disturbance input, for example a zero-phase low-pass filter. When the upcoming disturbance does not exceed any thresholds that would cause the system to violate any constraints (such as physical limits), then a filter frequency may be selected designed to set a certain desired trajectory. For example, in a vehicle suspension, for sections where the disturbance is small enough that entirely absorbing it would not require the suspension to exceed its travel limits, comfort of the occupants may be increased or substantially maximized by reducing or substantially eliminating motion of the vehicle superstructure housing the occupants by reducing the filter frequency, for example to below 0.1 Hz. In the embodiment illustrated in FIG. 12, a filter frequency below 0.1 Hz corresponds to the dash-dot line between 0-1 seconds, and between 5.5-10 seconds. According to various embodiments, other filter frequencies that are higher or lower than those noted here may be used as the disclosure is not so limited.

When the upcoming disturbance contains events that may cause the system to violate one or more constraints, for example, to exceed the travel limits of a controlled suspension system, then the disturbance input may be filtered at a higher frequency. In the embodiment illustrated in FIG. 12, a higher filter frequency corresponds to the section between 1-5.5 seconds, where the input signal is filtered for example at 0.8 Hz. According to various embodiments, other filter frequencies that are higher or lower than those noted here may be used as the disclosure is not so limited.

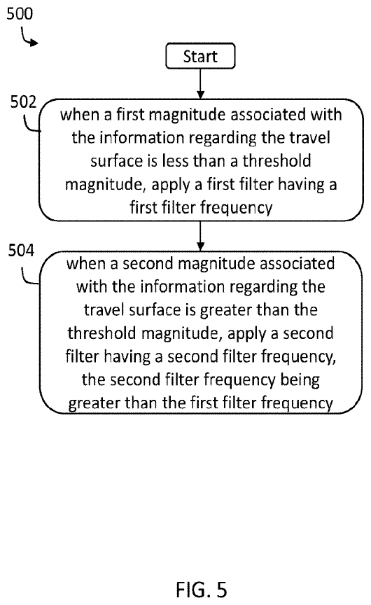

FIG. 5 shows a process flow 500 of one embodiment of a method related to comparing information regarding a travel surface to information regarding at least one physical constraint of a system. The process flow 500 may be carried out by a controller of a system, such as the processor 150 of the example of FIG. 1B, based on received information regarding the travel surface and information obtained by the controller regarding the physical constraint(s). Process flow 500 comprises step 502 and step 504. In step 502, when the controller determines that a first magnitude associated with the information regarding the travel surface is less than a threshold magnitude, the controller applies a first filter having a first filter frequency. Step 504 includes, when the controller determines that a second magnitude associated with the information regarding the travel surface is greater than the threshold magnitude, the controller applies a second filter having a second filter frequency, the second filter frequency being greater than the first filter frequency.

In some embodiments, a trajectory may be set by improving the performance of the system within the constraints, taking into account the upcoming disturbance. For example, in some embodiments of a suspension system, a third derivative of the vehicle superstructure's motion, jerk, may be a metric related to the comfort of the occupants. A controller may filter an upcoming road disturbance at variable filter frequencies to reduce or substantially minimize jerk while satisfying system constraints. For example, an algorithm may define a cost function that penalizes constraint violations, and values low jerk levels. Alternatively or additionally, the algorithm may first consider the highest violation in an upcoming road segment. From this point, a curve corresponding to a highest desired filter frequency can be derived (for example, in the example above it was 0.8 Hz) and the next highest point that exceeds the limits can be found, when including the trajectory drawn by the filter as described. Accordingly, a controller may successively build sections filtered at a given frequency, until the entire profile meets the system constraints. This process may be run on different size upcoming sections as soon as the information becomes available. For example, a road vehicle may take a turn off one road and onto the another, and at that point the information for the upcoming alternate road segment may be run through the process in order to calculate the improved trajectory for this road segment.

In some embodiments, the improved trajectory may be time-dependent, since the dynamics of the structure being controlled may have an impact on the estimation of the constraints. For example, for a road vehicle, when the vehicle travels at low forward speed, even large road inputs may feel relatively smooth and the vehicle may easily traverse the large road inputs without exceeding suspension travel limits. When traversing the same road at a higher speed, the dynamics of the vehicle may cause the vehicle to exceed travel limits even though at lower speed this was not a concern. Accordingly, the process described above may be calculated as a function of speed, while taking into account other factors, for example, without limitation, the vehicle's mass, geometric properties, component properties such as spring and tire stiffness, and others, which may also change over time.

Constraints may comprise travel limits, power, force/torque, or other actuator limits, or constraints may be relative to other parameters, such as the ability of a vehicle to maintain traction, or the ability of a controlled system to stay within bounds on other external parameters. External parameters may be related to overall system level constraints, such as total power consumption for multiple connected control devices, or total computation requirement. In some embodiments, motion of two or more systems may interfere with each other. With a priori knowledge of the appropriate trajectories, conflicts can be avoided while maintaining a high level of performance.

The description above applies to many different types of control systems. When a priori knowledge of upcoming disturbances is available, performance targets and operational constraints are known, this process may be used to plan out a strategy for a proactive controller to follow.

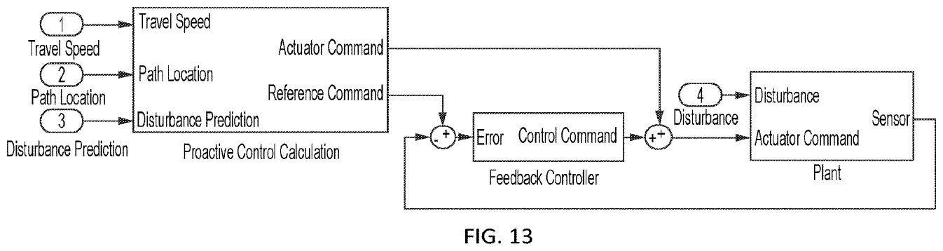

FIG. 13 shows an embodiment of a proactive controller in combination with a feedback loop. According to various embodiments, other controller configurations, such as those without feedback loops, with feedforward loops, as well as those for semi-active and partially active systems may be used as the disclosure is not so limited.

In the embodiment of FIG. 13, the feedback loop is similar to the feedback loop described in FIG. 8. The proactive control calculation block shown on the left calculates two outputs. First, it calculates an actuator command that is sized such that it creates a desired performance in terms of the response of the plant to the disturbance. As a second output, the resulting expected sensor signal is calculated, and supplied to the controller as a reference command. Accordingly, in this embodiment, the proactive control strategy may be insensitive to the feedback loop. If the actuator command from the proactive control results in the expected reference output from the sensors, then the feedback loop will see no error and thus take no action. If, on the other hand, there is an error, due for example to inaccuracies in the expected disturbance, then the feedback loop may work to correct the resulting motion.

In an embodiment of a proactive controller, a vehicle may be travelling over a known surface, for example, a previously recorded road. Accordingly, if the disturbance preview and the location of the vehicle are available then a time signal of the upcoming disturbance may be calculated if the vehicle travel speed is also known. For example, if a general road profile defined as z_{road}=f(s_{road}, y) is available, where the vertical height of the road z_{road} is a function of the longitudinal coordinate along the path s_{road} and the lateral location y. Knowing the location s_{current} along the path of the vehicle at any given time, and knowing the travel speed

$${V}_{s} = \frac{\partial s}{\partial t} ,$$

the upcoming vertical road velocity can be expressed as a function of time as

$$\frac{\partial z}{\partial t} = \frac{\partial z}{\partial s} {V}_{s} .$$

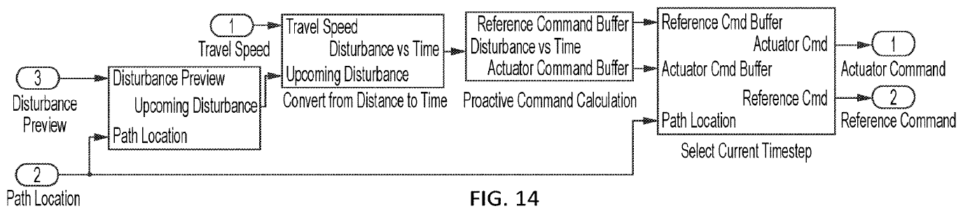

If this input is determined for each location along a section of the path, a time trace of command input for the control system may be calculated. Knowing the current path location, the appropriate command may be applied at the appropriate time in order to achieve the desired result. FIG. 14 shows aspects of an embodiment employing a proactive controller.

A quarter car model may represent a quarter of a vehicle, suspended above a single tire of a representative 4-wheeled vehicle. A quarter car model may be used to determine dynamics and mechanisms, but may not be a complete representation of a vehicle or suspension or the relative dynamics. For example, a quarter car model may be used to determine full vehicle or half vehicle behavior, such as for example heave, pitch, or roll movement of the vehicle. A quarter car model may be used inside a controller, with parameters chosen to represent some behaviors of the vehicle. For example, a linear quarter car model may represent the heave and pitch behavior of a road vehicle for larger amplitude inputs. FIG. 15 illustrates a simple quarter car model of a vehicle.

In the quarter car model of FIG. 15, the sprung mass M_{sprung} represents the mass of the vehicle body and all connected components, including occupants, powertrain, and the parts of the suspension that are attached to or effectively attached to the vehicle body. M_{unsprung} represents the mass of the wheel and all moving components attached to or effectively attached to it, such as for example brakes, wheel hub, and parts of the suspension links.

According to one embodiment, an active or semi-active suspension in FIG. 15 may apply a net force F_{act} on both the sprung and unsprung masses, as defined by a control strategy of the system. For example, the control strategy may attempt to reduce vertical acceleration of the sprung mass (to reduce discomfort for the occupants), or to reduce the derivative of vertical acceleration of the sprung mass, or to achieve other similar goals.

In some embodiments, the sum of forces on the sprung mass may be written as

$${F}_{total} = 0 = {K}_{s u s} ( {z}_{sprung} - {z}_{u nsprung} ) + {B}_{s u s} ( {\dot{z}}_{sprung} - {\dot{z}}_{u n s p r u n g} ) + {F}_{act} - {M}_{sprung} {\ddot{z}}_{sprung} \qquad Equation 1$$

Where Kₛᵤₛ is the simplified stiffness of the suspension spring, Bₛᵤₛ is the simplified total suspension damping, and F_{act} is the total actuator force. The parameters may be simplified and not necessarily account for some effects.

In some embodiments of a suspension controller of a vehicle, there may be two goals, isolation and tracking. In some embodiments, isolation and tracking may appear contradictory. For example, a controller may isolate the occupants from road input according to a goal of isolation and/or a controller may maintain contact between the vehicle and the ground, or track the ground contour according to a tracking goal. In some embodiments, a suspension system may also be designed to appropriately respond to vehicle handling inputs, such as from a steering system. In some embodiments, vehicle handling inputs may also be predicted by monitoring or determining the curvature of the road ahead, and applying similar proactive control strategies. In some embodiments of a ground vehicle, it may be desirable to isolate the occupants, but also desirable to follow the road contour. Providing isolation as well as tracking may be advantageous when a vehicle is driven by a person rather than an autonomous controller. For example, reduced tracking may result in a driver feeling disconnected from the road and may be interpreted as a loss of control by some drivers.

The inventors have recognized driver tracking perception may be related to low frequency tracking of the road contour, and that driver tracking perception may be improved by increased tracking at frequencies below a threshold frequency of, for example, 1 Hz or 1.5 Hz. According to various embodiments, a tracking threshold both higher and lower than those noted above may be used as the disclosure is not so limited.

According to various embodiments, a tracking goal may at least partially contradict an isolation goal. For example, more tracking may mean less isolation. In causal suspension design, the conflict between tracking and isolation may be resolved through heavy compromise, at a great loss of performance. For example, in a conventional suspension, spring and damping parameters may be adjusted to trade off isolation with tracking, and either produce the isolation of a comfortable sedan or the road holding of a sports car but rarely both.

Conventional suspensions, since the early days of the automotive industry have made many attempts to improve the compromise between providing tracking and isolation, including, for example, by using rubber tires, suspension springs, shock absorbers, and semi-active and active suspensions. A causal controlled suspension may be stiffer at low frequency and softer at high frequency, or may be soft for small disturbances and track larger disturbances but such causal controlled suspensions systems have limitations.

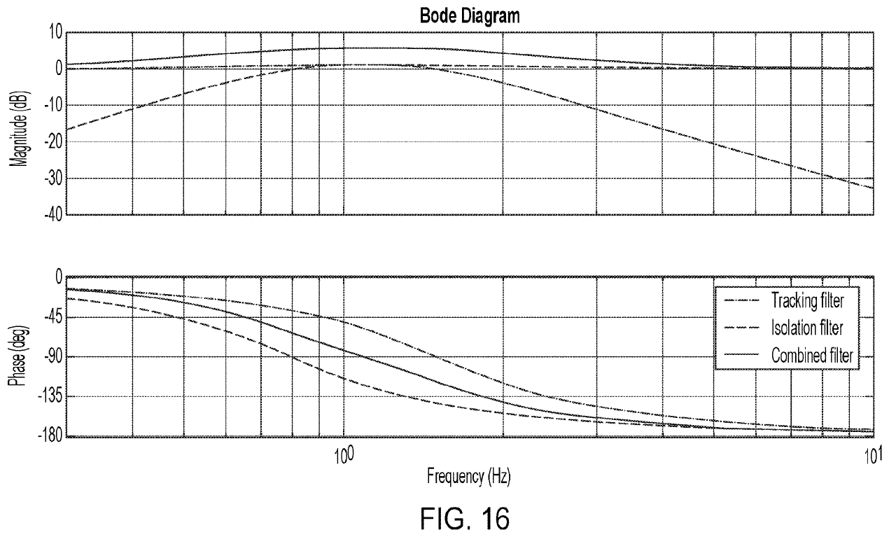

In some embodiments, a causal controller may be configured to track the road at low frequency, for example up to 1.5 Hz, as illustrated in FIG. 16 by the tracking filter graph. In some embodiments, a causal controller may be configured to isolate the vehicle body above 1.5 Hz, as illustrated in FIG. 16 by the isolation filter graph. In the upper half of the plot, the magnitude of the causal controller is shown; where for simplicity, that the desired magnitude is 1 (or 0 dB in the bode representation). In the lower half, the phase plot is shown. The phase angle of the tracking filter remains within 45 degrees of 0 degrees up to a frequency of about 0.9 Hz, while the phase angle of the isolation filter remains within 45 degrees of 180 degrees at frequencies equal to 1.5 Hz and above.

In some embodiments, when the two filters are combined, tracking may be attempted at very low frequencies, and isolation may be attempted at very high frequencies, and in a large range of frequencies (in this example between 0.2 and 4 Hz) neither tracking or isolation is very well provided (as can be seen by the phase). In addition, the desired magnitude may be exceeded by up to a factor of 2, which may lead to an unacceptable amplification of road disturbances.

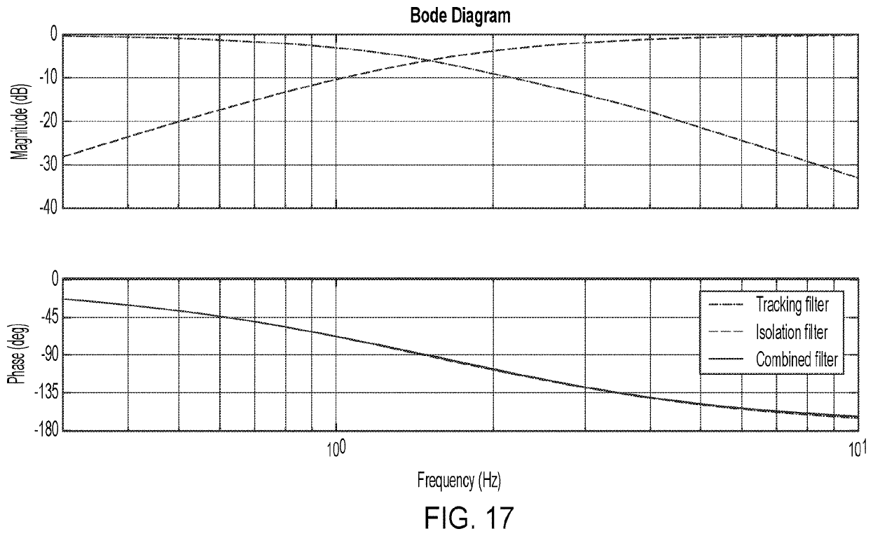

In some embodiments, behavior shown in FIG. 16 may be adjusted by reducing the performance at one or both ends of the spectrum, i.e. at low and high frequencies, for example by softening the causal controller shape and modifying the cutoff frequencies. FIG. 17 shows an example of such a configuration. As can be seen in FIG. 17, the amount of peaking (the amount that the combined function amplifies the road disturbance) is reduced but only at the expense of significant phase loss.

In this example, the tracking goal of remaining within 45 degrees of 0 phase may only be maintained up to about 0.6 Hz, and the isolation goal only above about 3.5 Hz.

These illustrative examples showing the shortcomings of causal controllers to both track and isolate inputs highlight the advantages of using proactive control, as already previously described. In some embodiments of controlled suspension, the competing requirements of tracking and isolation may be fulfilled by separate controllers and combined through an arbitration block. In some embodiments, controllers used for this purpose may be the skyhook and groundhook controllers.

In some embodiments, a proactive controller may both provide isolation and tracking of inputs from a travel surface.

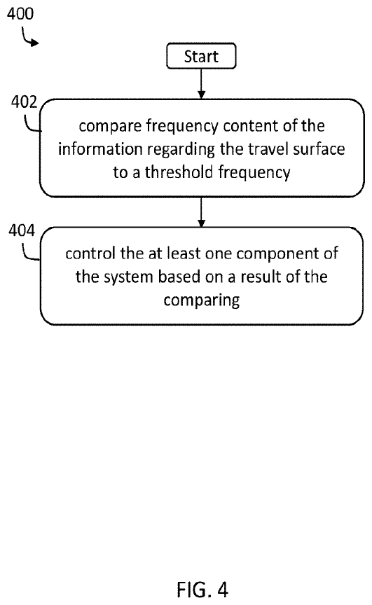

FIG. 4 shows a process flow 400 of one embodiment of a method related to controlling at least one component of a system based on information regarding the travel surface. The process flow 400 may be performed by a controller of the system, such as processor 150 of the example of FIG. 1B. Process flow 400 comprises step 402 and step 404. In step 402. the controller compares frequency content of the information regarding the travel surface to a threshold frequency. In step 404, the controller controls the at least one component of the system based on a result of the comparing.

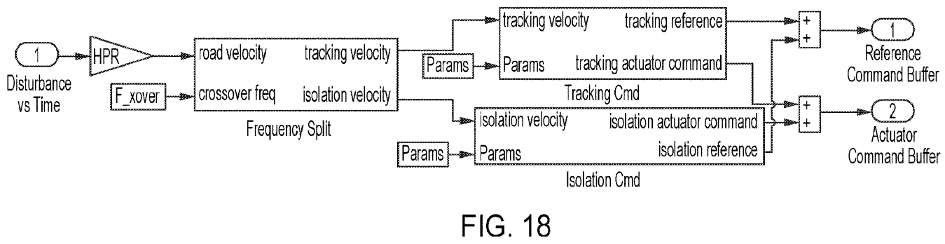

FIG. 18 shows an algorithm layout for an embodiment applying proactive control to a suspension system. A future disturbance input may be calculated as shown previously in FIG. 14 or alternatively received from, for example, a camera, radar, or Lidar system or some other a priori knowledge of the upcoming disturbance. The disturbance input may be resolved into the directions that may be controlled with the suspension. In some embodiments the controlled directions may be heave, pitch, and roll of the vehicle, but they could be aligned according to different orientations (such as front, rear, and roll, or left, right, and pitch) and depend on the type of suspension actuation system that is being controlled.

Next, zero-phase filtering may be used to separate the frequency content of the disturbance that is to be tracked, from the content from which the vehicle is to be isolated. This frequency split may be a tuning parameter determined based on desired performance, and/or the frequency split may vary over time, from vehicle to vehicle, and/or depending on external factors and user settings. It is relevant in this context that there is a frequency split, and that the filter applied to the incoming data is acausal and thus can separate frequency regions without adding or subtracting phase to the response, thus not creating any delays or related side effects.

Next, a tracking command is calculated from the tracking component of the disturbance, and an isolation command is calculated from the isolation component of the disturbance. Both commands may create a reference for the sensors as illustrated in FIG. 13, and an actuator command.

The tracking and isolation commands may then be integrated into the control system, for example, as shown in FIG. 13 and create a command that achieves objectives in both tracking and isolation with little or effectively no side effects.

An embodiment of an algorithm for a controlled suspension system is described below. Using a quarter car model as discussed previously, the force required, and the motion expected, may be determined for improved tracking and isolation.

According to some embodiments, a starting assumption may be that the tire is infinitely stiff. For example, this assumption may be used for simplification or demonstration of concepts. In some embodiments, such an assumption may be used when the desired operating range of the system is below the natural frequency of the unsprung mass. In some vehicles, the natural frequency is about 12-15 Hz, and therefore, when the isolation to be applied is only up to about 8-10 Hz, the infinite tire stiffness assumption may be used. In some embodiments, the infinite tire stiffness assumption may not be used. When the vehicle perfectly tracks the road:
1) The acceleration of the sprung mass will be equal or effectively equal to the acceleration imparted by the road
2) The displacement of the suspension elements is zero or effectively equal to zero

In Equation 1, setting the suspension displacement to zero and replacing the sprung mass acceleration with the road acceleration, the total force is zero when

Fₜₒₜₐₗ=0=Kₛᵤₛ(z_{sprung}−z_{unsprung})+Bₛᵤₛ(\dot{z}_{sprung}−ż_{unsprung})+F_{act}−M_{sprung}\ddot{z}^{sprung}

And thus

F_{act}=M_{sprung}\ddot{z}_{road}

Accordingly, the actuator command for the tracking portion of the algorithm is the estimated simplified mass of the vehicle superstructure in the direction that is being controlled (for example heave, pitch, roll), multiplied by the acceleration of the disturbance (in this case the road input).

One goal of isolation is to reduce the sprung mass acceleration to zero or effectively zero. Accordingly, setting the sprung mass acceleration to zero in Equation 1 and replacing the unsprung mass motion with the road disturbance (the tire is assumed infinitely stiff in this embodiment of the algorithm), the total force required is

F_{act}=−Kₛᵤₛz_{road}−Bₛᵤₛż_{road}

Thus, in this embodiment the tracking and isolation components of the actuator command can be calculated by multiplying the disturbance position, velocity, and acceleration by the appropriate values.

In this embodiment, in order to determine the reference command to send to the sensors, the expected output from the sensors is calculated. In this embodiment, for the tracking frequencies the motion of the sprung mass is assumed to be equal to the disturbance, and the suspension motion is assumed to be zero or effectively zero. For the isolation frequencies, the motion of the sprung mass is assumed to be zero or effectively zero and the motion of the suspension is assumed to be equal and opposite to the disturbance input.

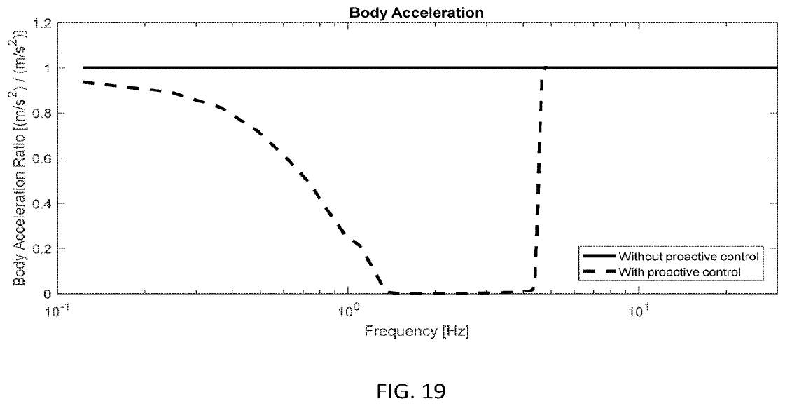

In this embodiment, when tuning a proactive controller, the behavior of an active suspension system may be simulated in a quarter car model to provide tracking (thus, a reduction in suspension position) up to 1.5 Hz, and to provide isolation (thus, a reduction in body acceleration) from 1.5 Hz to 4 Hz. An exemplary comparison between the performance of proactive control and a feedback loop control is illustrated in FIG. 19. The comparison shows that a reduction of at least 90% may be achieved with proactive control relative to the body acceleration achieved without proactive control.

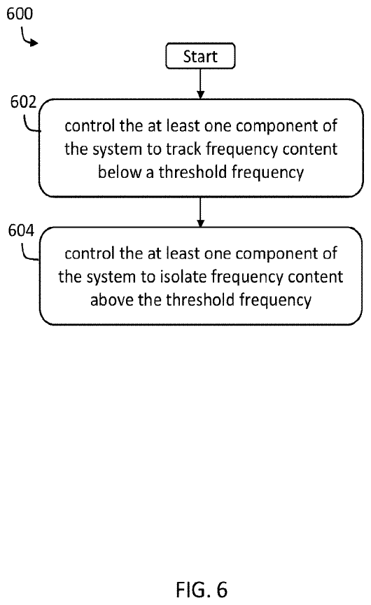

FIG. 6 shows a process flow 600 of one embodiment of a method related to controlling at least one component of a system based on information regarding a travel surface. The process flow 600 may be performed by a controller of the system, such as processor 150 of the example of FIG. 1B. Process flow 600 comprises step 602 and step 604. At step 602, for frequency content identified by the controller to be below a threshold frequency, the controller controls the at least one component of the system to track the frequency content below the threshold frequency. At step 604, for frequency content identified by the controller to be above the threshold frequency, the controller controls the at least one component of the system to isolate the frequency content above the threshold frequency. In some embodiments, both steps 602 and 604 are performed for detected frequencies in both ranges, and may be performed contemporaneously, rather than in a sequence.

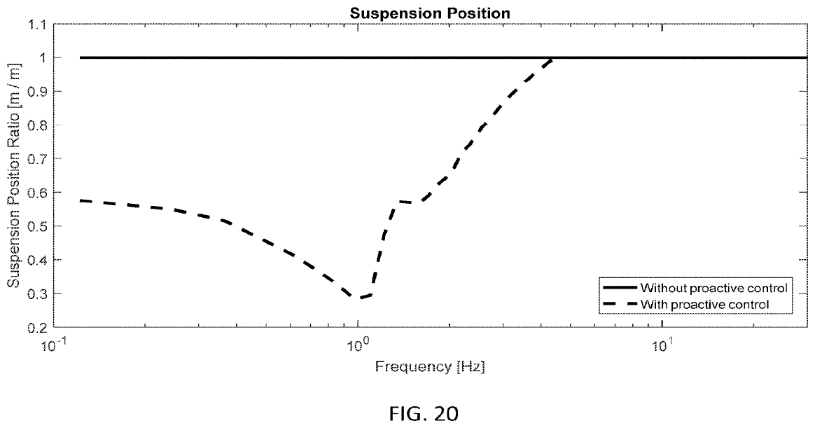

FIG. 20 shows the corresponding ratio of suspension position (as a stand-in for the tracking metric) for the exemplary proactive controller and the exemplary system without proactive control, showing a reduction below 1.5 Hz of up to 70%.

This embodiment may use only 3 distinct sets of parameters per degree of freedom to be controlled. The quarter car model may be presented in linearized form (as described above) but may also account for many of the common nonlinear effects that may be relevant for suspension performance, such as friction, digressive damping, progressive springs, and other typical nonlinearities present in road and vehicle suspensions. According to some embodiments, one nonlinear effect may be the variability of components as a function of temperature. For example, dampers may be stiffer at low temperature than at high temperature, which may be mapped and included in the parameter settings.

In the embodiment described above, this proactive control method may be insensitive to the presence or absence of a feedback controller operating in conjunction with it. Therefore, this proactive control method may not need to change if the tuning of the feedback controller is changed.

Another feature of the algorithm described above is that like other proactive control algorithms described herein, zero-phase filtering may be used. Use of zero-phase filtering allows the use of very sharp or high order filters to separate the frequency ranges in which to isolate and track. High order filters applied with zero-phase filtering may produce improved performance all the way up to the cutoff frequency. A causal filter may not produce improved performance all the way up to the cutoff frequency, because in a causal filter, the phase latency of the filter increases with its order, and thus the side effects of filtering become more and more pronounced.

As described above, base tuning for an algorithm may be based on physical properties and may therefore be established from testing, modeling, or estimates. Testing may include kinematics and compliance rig testing (for example, K&C testing) to establish vehicle properties such as spring stiffness and damping, and to estimate the vehicle mass in the different degrees of freedom that can be obtained from design parameters or through measurements on vehicle scales or similar devices.

Alternatively or additionally, the algorithm may be auto-tuned during operation. An estimator algorithm may update the parameter tuning to increase performance. When the disturbance is known, and when given a desired performance goal (for example, a reduction in suspension motion in a defined frequency range for tracking, and/or a reduction in vehicle body acceleration in another defined frequency range), an adaptive control tuning strategy may be implemented, for example, based on Kalman filtering. In this manner performance may improve over time and adapt to changes in the vehicle's parameters. Such changes may be due to, for example, vehicle loading, component wear, and changes in component characteristics.

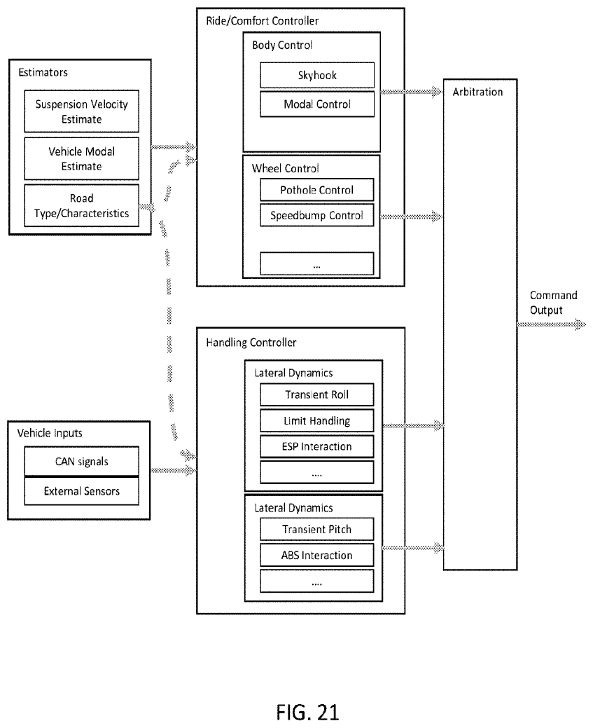

FIG. 21 shows an exemplary layout of a vehicle suspension causal control system. It is split into a ride (for example, comfort) controller, and a handling controller. The ride controller controls the vehicle superstructure (for example, the sprung mass or vehicle body) and the wheels (for example, unsprung mass or corner modules) to provide comfort and low vibration and harshness levels from wheel frequency inputs, while providing good road following and low incidence of end-of-travel events. Specific controller blocks may include a skyhook control for comfort, modal control of the vehicle's resonant modes, and others as part of the body control algorithm, and wheel control strategies such as pothole control, hillcrest control, speed bump control or others as part of the wheel control algorithm.

Some signals may be estimated based on sensor inputs and on sensor fusion techniques where multiple sensors are blended into one output, taking into account the accuracy and quality of each in a given frequency range, state of operation, and time. Some estimated signals may include suspension velocity, vehicle modal behavior, and road characteristics such as roughness or texture.

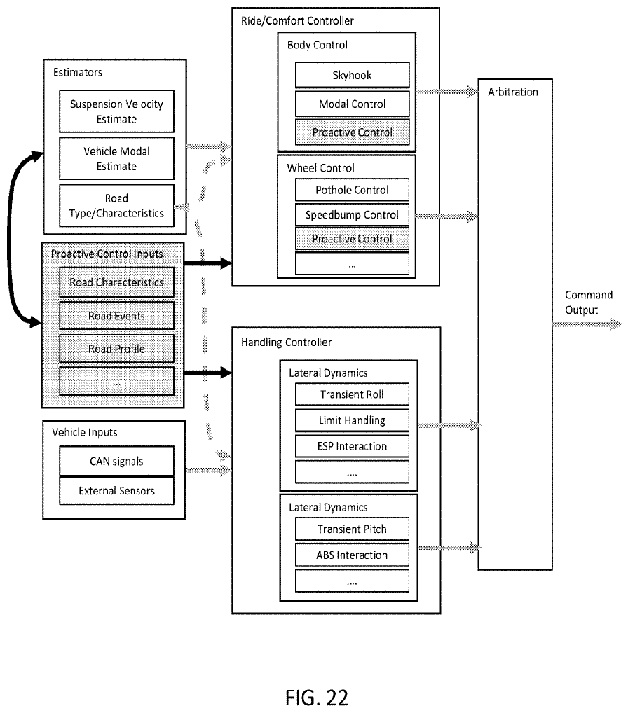

FIG. 22 shows an integration of proactive control into the algorithm structure of FIG. 21, with added inputs defining the road characteristics, road events, and road profiles among others, and added controller blocks to support the additional information within the body and wheel control modules.

The proactive control methods described, may be applied to systems encountering predictable input, which can be measured a priori; predicted substantially from previous encounters; or predicted substantially based on input from other users. Systems that may benefit from proactive control include any road or off-road vehicle, especially ones driving on hard surfaces where the input may be repeatable for a substantial period of time; boats and ships if the input is predictable through camera or other sensor systems; trains and other rail-bound vehicles; robotic devices such as warehouse robots, assembly robots, or delivery robots; and other controlled devices that encounter predictable and/or position dependent disturbance signals.

For vehicle suspension systems, the proactive control methods described may be applied to semi-active and active suspensions, active roll systems, and active steering and braking systems. The proactive control methods described may also be applied to advanced driver-assistance systems (ADAS) to inform the strategy for steering, acceleration and braking of an autonomous or semi-autonomous vehicle based on repeatable disturbance inputs such as the upcoming road events.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. A method comprising:
obtaining information regarding a travel surface along a travel path that a system will travel at a future time; and
based on the information regarding the travel surface, controlling at least one component of the system to traverse the travel surface, wherein controlling the at least one component based on the information regarding the travel surface comprises:
comparing the information regarding the travel surface to information regarding at least one physical constraint of the system; and
controlling the at least one component of the system based on at least one setpoint related to a result of the comparing.

2. The method of claim 1, wherein controlling the at least one component of the system based on the at least one setpoint related to a result of the comparing the information regarding the travel surface to information regarding at least one physical constraint of the system comprises:
when a first magnitude associated with the information regarding the travel surface is less than a threshold magnitude, applying a first filter having a first filter frequency; and
when a second magnitude associated with the information regarding the travel surface is greater than the threshold magnitude, applying a second filter having a second filter frequency, the second filter frequency being greater than the first filter frequency.

3. The method of claim 1, wherein the system is an automobile and controlling the at least one component of the system to traverse the travel surface comprises controlling at least one component of the automobile to traverse the travel surface.

4. The method of claim 3, wherein:
the at least one component comprises a suspension of the automobile; and
the at least one physical constraint of the system comprises a travel limit of the suspension.

5. The method of claim 1, wherein controlling the at least one component based on the information regarding the travel surface further comprises:
based on the information regarding the travel surface, determining an expected signal of a sensor of the system in response to detection of the travel surface while the system is traversing the travel surface; and
while the system is traversing the travel surface at the future time, additionally controlling the at least one component of the system based on the expected signal of the sensor and a signal output by the sensor in response to detection of the travel surface while the system is traversing the travel surface.

6. The method of claim 1, further comprising, at a time prior to the obtaining, capturing the information regarding the travel surface along the travel path.

7. The method of claim 1, wherein the information regarding the travel surface along the travel path comprises a topography of a road surface.

8. The method of claim 1, wherein controlling the at least one component based on the information regarding the travel surface further comprises applying a zero-phase filter to the information regarding the travel surface along the travel path.

9. The method of claim 1, wherein controlling the at least one component of the system based on at least one setpoint comprises controlling the at least one component of the system based on at least one frequency, gain, or calibration factor.

10. At least one computer-readable storage medium having encoded thereon executable instructions that, when executed by at least one controller, cause the at least one controller to carry out the method of claim 1.

11. A system comprising:
at least one controller, the at least one controller configured to execute a method comprising:
obtaining information regarding a travel surface along a travel path that the system will travel at a future time; and
based on the information regarding the travel surface, controlling at least one component of the system to traverse the travel surface, wherein controlling the at least one component based on the information regarding the travel surface comprises:
comparing the information regarding the travel system to information regarding at least one physical constraint of the system; and
controlling the at least one component of the system based on at least one setpoint related to a result of the comparing.

12. The system of claim 11, wherein comparing the information regarding the travel surface to information regarding at least one physical constraint of the system comprises:
when a first magnitude associated with the information regarding the travel surface is less than a threshold magnitude, applying a first filter having a first filter frequency; and
when a second magnitude associated with the information regarding the travel surface is greater than the threshold magnitude, applying a second filter having a second filter frequency, the second filter frequency being greater than the first filter frequency.

13. The system of claim 11, wherein the system is an automobile and controlling the at least one component of the system to traverse the travel surface comprises controlling at least one component of the automobile to traverse the travel surface.

14. The system of claim 13, wherein:
the at least one component comprises a suspension of the automobile; and
the at least one physical constraint of the system comprises a travel limit of the suspension.

15. The system of claim 11, wherein controlling the at least one component based on the information regarding the travel surface further comprises applying a zero-phase filter to the information regarding the travel surface along the travel path

16. A method comprising:
obtaining information regarding a travel surface along a travel path that a system will travel at a future time; and
based on the information regarding the travel surface, controlling at least one component of the system to traverse the travel surface, wherein controlling the at least one component based on the information regarding the travel surface comprises:
comparing frequency content of the information regarding the travel surface to a threshold frequency; and
controlling the at least one component of the system based on a result of the comparing.

17. The method of claim 16, wherein controlling the at least one component based on the information regarding the travel surface further comprises:
controlling the at least one component of the system to track frequency content below a threshold frequency; and
controlling the at least one component of the system to isolate frequency content above the threshold frequency.

18. The method of claim 16, wherein the system is an automobile and controlling the at least one component of the system to traverse the travel surface comprises controlling at least one component of the automobile to traverse the travel surface.

19. The method of claim 18, wherein the at least one component comprises a suspension of the automobile.

20. The method of claim 16, further comprising, at a past time, capturing the information regarding the travel surface along the travel path.

21. The method of claim 16, wherein the information regarding the travel surface along the travel path comprises a topography of a road surface.

22. The method of claim 16, wherein controlling the at least one component based on the information regarding the travel surface further comprises applying a zero-phase filter to the information regarding the travel surface along the travel path.

23. At least one computer-readable storage medium having encoded thereon executable instructions that, when executed by at least one controller, cause the at least one controller to carry out the method of claim 16.
